(19) United States
(12) Patent Application Publication
(10) Pub. No.: US 2023/0314602 A1
(43) Pub. Date: Oct. 5, 2023

(54) METHOD, SYSTEM, AND COMPUTER PROGRAM PRODUCT FOR DETERMINING THE POSITION OF A MOVING OBJECT RELATIVE TO ANOTHER OBJECT

(71) Applicant: Dr. Ing. h.c. F. Porsche Aktiengesellschaft, Stuttgart (DE)

(72) Inventors: Muhammed Tuerker, Stuttgart (DE); Ehsan Sharafian Ardakani, Ehningen (DE); Janik Chrobak, Filderstadt (DE)

(21) Appl. No.: 18/129,557

(22) Filed: Mar. 31, 2023

(30) Foreign Application Priority Data
Apr. 1, 2022 (DE) 10 2022 107 847.7

(51) Int. Cl. G01S 13/931; G01S 7/285; G01S 13/02; G01S 13/42

(52) U.S. Cl. CPC G01S 13/931; G01S 7/285; G01S 13/0209; G01S 13/42; G01S 2013/932

(57) ABSTRACT

The invention relates to a method for determining the position of a moving first object relative to another second object,

comprising the following method steps:
transmitting a first pulse signal S1 from a first transmitter (12) of the first object to a first receiver (22) of the second object, and returning the first pulse signal S1 from the first receiver (22) of the second object to the first transmitter (12) of the first object, wherein a first distance d1 between the first transmitter (12) and the first receiver (22) can be derived from a travel time Δt1 of the first pulse signal Si;
transmitting a second pulse signal S2 from a second transmitter (14) of the first object to the first receiver (22) and returning the second pulse signal S2 from the first receiver (22) of the second object to the second transmitter (14) of the first object, wherein a second distance d2 between the second transmitter (14) and the first receiver (22) can be derived from a travel time Δt2 of the second pulse signal S2;
forwarding the first distance d1 and/or the travel time Δt1 of the first pulse signal S1 and the second distance d2 and/or the travel time Δt2 of the second pulse signal S2 to a data processing module (30);
calculating a distance d and an angle β between the first object and the second object.

The invention relates to a method, system, and a computer program product for determining the position of a moving object relative to another object.

The trend towards driving assistance systems and highly automated driving functions in vehicles requires an accurate knowledge of the position of the vehicle relative to other objects, in particular other vehicles, in order to detect possible collisions early, for example, and then develop suitable control options for the vehicle.

Also for other situations, knowledge of the distance between two vehicles is important, for example, in the case of combine harvesters or cleaning devices that process a surface side-by-side, or in air traffic, for example for drones.

ADMA systems are known to be used for determining the position of one vehicle relative to another vehicle. ADMA is an abbreviation for Automotive Dynamic Motion Analyzer and refers to a high-precision centrifugal measurement system with DGPS (Differential Global Positioning System) that can be used to determine acceleration, speed, and position for moving vehicles relative to all three spatial axes. However, ADMA systems are costly and bound to a reference point within a circumference of about 3 km. They are primarily used for test measurements on test vehicles.

DE 10 2018 120 655 A1 discloses three motor vehicles, wherein the distance between a first motor vehicle and a second and third motor vehicle is known. The distance between the second and third motor vehicles is determined by trigonometry.

DE 10 2017 007 980 A1 describes a method for maintaining a formation between multiple motor vehicles, wherein the distance in the direction of travel is determined by means of trigonometric calculations from the direct distance and the angle between the motor vehicles.

DE 10 2021 001 176 A1 describes a method for detecting an impending frontal collision between two vehicles, wherein a first motor vehicle detects a headlight of an oncoming second motor vehicle by means of a camera, and a transverse offset of the first motor vehicle relative to the second motor vehicle is calculated by means of trigonometry.

DE 10 2012 104 746 A1 discloses a method for determining a position of a first motor vehicle relative to a second motor vehicle, wherein the first motor vehicle comprises a locating unit and the second motor vehicle comprises a transponder.

The problem underlying the invention is now to create a method, system, and computer program product for determining the position of a moving object relative another object that is characterized by high reliability, safety, and accuracy and can be easily implemented.

According to the present invention, a method, system, and computer program product are proposed, with which the position of a moving object relative to another moving object can be determined precisely and at a low cost.

This problem is solved according to the invention with respect to a method by the features of claim 1, with respect to a system by the features of claim 11, and with respect to a computer program product by the features of claim 15. The further claims relate to preferred configurations of the invention.

According to a first aspect, the invention provides a method for determining the position of a moving first object relative another second object. The method comprises the following method steps:
transmitting a first pulse signal S1 having a short temporal pulse duration from a first transmitter of the first object to a first receiver of the second object, and returning the first pulse signal S1 from the first receiver of the second object to the first transmitter of the first object, wherein a first distance d1 between the first transmitter and the first receiver can be derived from a travel time Δt1 of the first pulse signal S1,
transmitting a second pulse signal S2 having a short temporal pulse duration from a second transmitter of the first object to the first receiver\ of the second object and returning the second pulse signal S2 from the first receiver of the second object to the second transmitter of the first object, wherein a second distance d2 between the second transmitter and the first receiver can be derived from a travel time Δt2 of the second pulse signal S2;
forwarding the first distance d1 and/or the travel time Δt1 of the first pulse signal S1 and the second distance d2 and/or the travel time Δt2 of the second pulse signal S2 to a data processing module;
calculating a distance d and an angle β between the first object and the second object.

It is provided in a further development that, for calculating the distance d and the angle β between the first object and the second object, the law of cosines for planar triangles from trigonometry is used, wherein c is the distance between the first transmitter and the second transmitter:

c²=d1²+d2²−2·d1·d2·cos γ

Advantageously, a sensor module is used in particular with a camera device for recording further data in order to limit the possible location of the second object.

In an advantageous embodiment, it is provided that the first object comprises a third transmitter, which transmits a third pulse signal S3 having a short temporal pulse duration to a second receiver of the second object, which signal is returned from the second receiver of the second object to the third transmitter of the first object, wherein a third distance d3 between the third transmitter and the second receiver can be calculated from a travel time Δt3 of the third pulse signal S3.

In a further embodiment, it is provided that the first object comprises a fourth transmitter, which transmits a fourth pulse signal S4 having a short temporal pulse duration to the second receiver of the second object, which signal is returned from the second receiver of the second object to the fourth transmitter of the first object, wherein a fourth distance d4 between the fourth transmitter and the second receiver can be calculated from a travel time Δt4 of the fourth pulse signal S4.

In particular, it is provided that the pulse signals P1, P2, P3, P4 are generated by ultra-wideband (UWB) technology.

Advantageously, the data processing module and/or the receivers are in communication with a cloud computing infrastructure via a communications link.

In particular, the communications link is configured as a cellular link and/or a near field communications link such as Bluetooth®, Ethernet, NFC (near field communication), or Wi-Fi®.

It is provided in a further development that the data processing module comprises algorithms of artificial intelligence and machine learning, in particular neural networks.

In particular, the transmitters and/or the data processing module are equipped with radio modules of the 5G standard.

In one embodiment, it is provided that the objects are configured as a motor vehicle or as a self-driving vehicle or as an agricultural vehicle such as a combine harvester or as a robot or as a cleaning device such as a self-driving cleaning robot or as a watercraft or as a flying object such as a drone.

According to a second aspect, the invention provides a system for determining the position of a moving first object relative to another second object with a data processing module. The first object comprises at least a first transmitter and at least a second transmitter, and the second object comprises at least a first receiver. The first transmitter is configured so as to transmit a first pulse signal S1 having a short pulse duration to the first receiver. The first receiver is configured so as to return the first pulse signal S1 to the first transmitter. The first transmitter is configured so as to forward a travel time Δt1 of the first pulse signal S1 to the data processing module. The second transmitter is configured so as to transmit a first pulse signal S2 having a short temporal duration to the first receiver. The first receiver is configured so as to return the second pulse signal S2 to the second transmitter, and the second transmitter is configured so as to forward a travel time Δt2 of the second pulse signal S2 to the data processing module. The data processing module is configured so as to derive a first distance d1 between the first transmitter and the first receiver from the travel time Δt1 of the first pulse signal S1 and a second distance d2 between the second transmitter and the first receiver from the travel time Δt2 of the second pulse signal S2 and to calculate therefrom a distance d and an angle β between the first object and the second object.

In a further development, it is provided that, for calculating the distance d and the angle β between the first object and the second object, the law of cosines for planar triangles from trigonometry is used, wherein c is the distance between the first transmitter and the second transmitter:

c²=d1²+d2²−2·d1·d2·cos γ

In one advantageous embodiment, it is provided that the first object comprises a third transmitter and the second object comprises a second receiver. The third transmitter of the first object is configured so as to transmit a third pulse signal S3 having a short temporal duration to the second receiver of the second object, and the second receiver of the second object is configured so as to return the third pulse signal S3 to the third transmitter of the first object, wherein a third distance d3 between the third transmitter and the second receiver can be derived from a travel time Δt3 of the third pulse signal S3.

In particular, it is provided that the transmitters are configured so as to generate pulse signals P1, P2, P3 by means of ultra-wideband (UWB) technology.

According to a third aspect, the invention relates to a computer program product comprising an executable program code configured so as to carry out the method according to the first aspect when it is executed.

The invention is explained in further detail below on the basis of an embodiment example shown in the drawings.

The figures show:

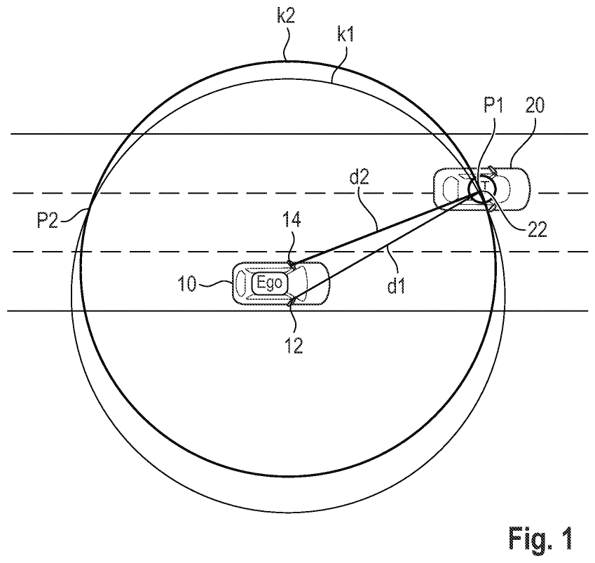

FIG. 1 a schematic view of a first embodiment example of the system according to the invention;

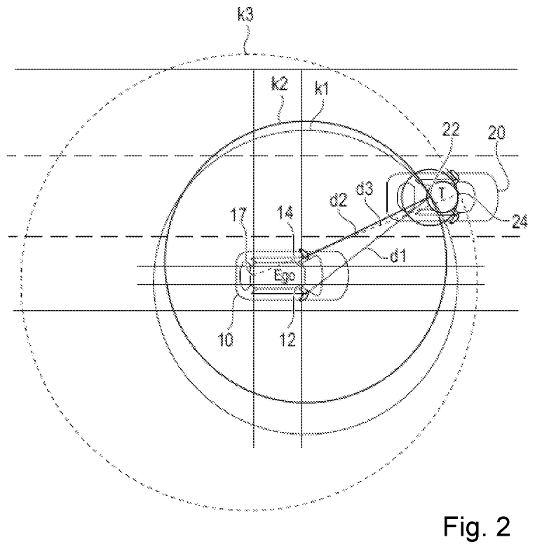

FIG. 2 a schematic view of a second embodiment example of the system according to the invention;

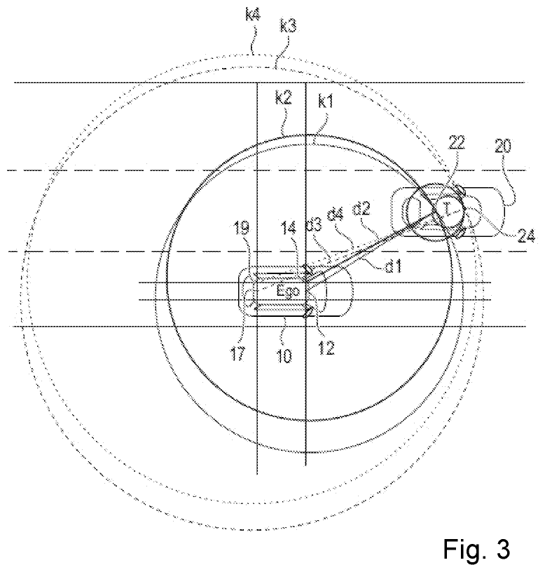

FIG. 3 a schematic view of a third embodiment example of the system according to the invention;

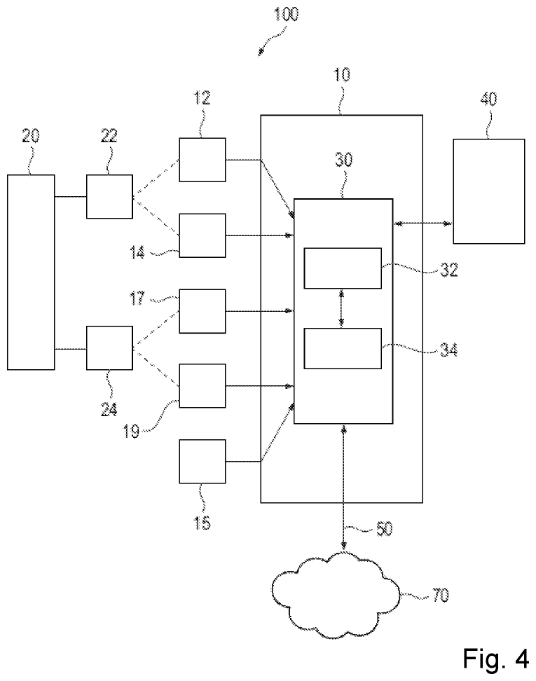

FIG. 4 a block diagram for explaining an embodiment example of the system according to the invention;

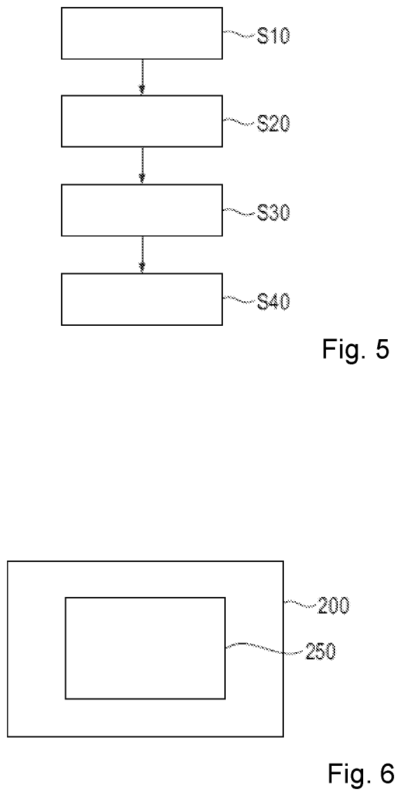

FIG. 5 a flow chart for explaining the individual method steps of the method according to the invention;

FIG. 6 schematically, a computer program product according to an embodiment of the third aspect of the invention.

Additional characteristics, aspects, and advantages of the invention or its embodiment examples will be apparent from the detailed description in connection with the claims.

FIG. 1 shows a first embodiment example of a system 100 for determining the position of a moving object 10 relative to another object 20. In particular, the object 20 is also a moving object. The objects 10, 20 can be, for example, a motor vehicle, a self-driving vehicle, an agricultural vehicle such as a combine harvester, a robot, a cleaning device such as a self-driving cleaning robot, or a watercraft or a flying object such as a drone. If the object 20 is a non-moving object, it can be an object such as a wall or a container, etc.

The moving first object 10 is located at a particular distance d from the second object 20 at a time t. Because the object 10 at least moves on a trajectory, the distance d between the two objects 10, 20 continuously changes over time so that a determination of the distance d in real time is required in order to obtain accurate knowledge of the actual distance at time t.

The first object 10 is equipped with two transmitters 12, 14, and the second object 20 is equipped with a first receiver 22. The first transmitter 12 transmits a first pulse signal S1 having a short temporal pulse duration to the first receiver 22, and the second transmitter 14 transmits a second pulse signal S2 having a short pulse duration to the first receiver 22. The first receiver 22 returns the first pulse signal S1 to the first transmitter 12, and the second pulse signal S2 to the second transmitter 14. A first distance d1 between the first transmitter 12 and the first receiver 22 can be derived from a travel time Δt1 of the first pulse signal S1, and a second distance d2 between the second transmitter 14 and the first receiver 22 can be derived from the travel time Δt2 of the second pulse signal S2.

A first circle k1 denotes the circle with the first transmitter 12 as the center point and a radius corresponding to the distance d1 between the first transmitter 12 and the receiver 22. A second circle k2 denotes the circle with the second transmitter 14 as the center point and a radius corresponding to the distance d2 between the second transmitter 14 and the receiver 22. In a two-dimensional view, it is understood that the first object 10 and the second object 20 are on a surface and the circles k1 and k2 are arranged in that plane. In a three-dimensional view, the common surface is a section plane in space.

As can be seen in FIG. 1, the two circles k1 and k2 intersect at the two points P1 and P2. The second object 20 can thus be located at either the location P1 or the location P2. To exclude the location P2, a sensor module 15 such as a camera device is used, for example, which records the environment of the object 20. If no object 20 is captured by the camera equipment at the location P2, it is to be assumed that no object is present at this location P2. The sensor module 15 is in particular arranged on the first object 10.

By means of the law of cosines for planar triangles from trigonometry, the distances d1 and d2 result as follows, wherein c denotes the distance between the first transmitter 12 and the second transmitter 14:

c²=d1²+d2²−2·d1·d2·cos γ

d1²=d2²+c²−2·d2·c·cos β

d2²=d1²+c²−2·d1·c·cos α

This results in the angle β between the first object 10 and the second object 20 according to:

$$β = arccos ( \frac{d {1}^{2} - {c}^{2} - d {2}^{2}}{2 \cdot d 2 \cdot c} )$$

Again, an averaged distance d between the first object 10 and the second object 20 can be calculated from the distances d1 and d2. For calculations in 3-dimensional space for flight objects such as drones, the law of cosines for spherical triangles can be used correspondingly.

FIG. 2 shows a further embodiment example of a system 100 for determining the position of a moving first object 10 relative to another moving second object 20. In this case, the second object 20 adjacent to the first receiver 22 is equipped with a second receiver 24, and the first object 10 is equipped with an additional third transmitter 17 that transmits a third pulse signal S3 having a short pulse duration. The pulse signal S1 of the first transmitter 12 is received by the receiver 22 as in the first embodiment example and then returned to the first transmitter 12. Communication with the second receiver 24 is established with the pulse signal S3 of the third transmitter 17, and the second receiver 24 returns the pulse signal S3 to the third transmitter 17. A distance d3 between the third transmitter 17 and the second receiver 24 can be derived from a travel time Δt3 of the pulse signal S3.

A first circle k1 again denotes the circle with the first transmitter 12 as the center point and a radius corresponding to the distance d1 between the first transmitter 12 and the first receiver 22. A second circle k2 denotes the circle having the second transmitter 14 as the center point and a radius corresponding to the distance d2 between the second transmitter 14 and the first receiver 22. A third circle k3 denotes the circle with the third transmitter 17 as the center point and a radius corresponding to the distance d3 between the third transmitter 17 and the second receiver 24. The average distance d between the first object 10 and the second object 20 is again calculated by the distance d1 between the first receiver 22 and the first transmitter 12 and the distance d2 between the first receiver 22 and the second transmitter 14. By determining the distance d3 between the third transmitter 19 and the second receiver 24, it can be determined whether the second object 20 is located at the first intersection P1 or at the second intersection P2 of the circles k1 and k2. In the example shown in FIG. 2, the distance d3 is significantly larger at the location P1 than at the location P2. Thus, the determined distance d3 in relation to the determined distances d1 and d2 indicates whether the second object 20 is at the location P1 or at the location P2.

FIG. 3 shows a further embodiment example of a system 100 for determining the position of a moving object 10 relative to another moving object 20. In this case, the first object 10 is equipped with a fourth transmitter 19 adjacent to the first transmitter 12, the second transmitter 14, and the third transmitter 17. The fourth transmitter 19 transmits a pulse signal P4 having a short pulse duration. The distance between the first transmitter 12 and the second transmitter 14 is again referred to as c, and the distance between the third transmitter 17 and the fourth transmitter 19 is referred to as c1. The object 20 comprises the two receivers 22 and 24. The pulse signal S1 of the first transmitter 12 is received by the first receiver 22 and returned to the first transmitter 12, as in the first embodiment example. The pulse signal S2 of the second transmitter 14 is also received by the first receiver 22 and returned to the second transmitter 14. The pulse signal S3 of the third transmitter 17 is returned by the second receiver 24 to the third transmitter 17. The pulse signal S4 of the fourth transmitter 19 is received by the fourth receiver 19 and returned to the fourth transmitter 19 by the receiver 24. A first circle k1 again denotes the circle with the first transmitter 12 as the center point and a radius corresponding to the distance d1 between the first transmitter 12 and the first receiver 22. A second circle k2 denotes the circle having the second transmitter 14 as the center point and a radius corresponding to the distance d2 between the second transmitter 14 and the first receiver 22. A third circle k3 denotes the circle with the third transmitter 17 as the center point and a radius corresponding to the distance d3 between the third transmitter 17 and the second receiver 24. A fourth circle k4 denotes the circle with the fourth transmitter 19 as the center point and a radius corresponding to the distance d4 between the fourth transmitter 19 and the second receiver 24.

From the distance d1 and the distance d2 between the first object 10 and the second object 20 as well as the distance c between the first transmitter 12 and the second transmitter 14, the average distance d and the angle β between the first object 10 and the second object 20 can be calculated by means of the law of cosines.

From the distance d3 and d4, a second average distance d* and a second angle β* between the first object 10 and the second object 20 can also be calculated by means of the law of cosines for planar triangles from trigonometry, according to:

c1²=d3²+d4²−2·d3·d4·cos γ*

d3²=d4²+c1²−2·d4·c1·cos β*

d4²=d3²+c1²−2·d3·c1·cos α*

This results in the second angle β* between the first object 10 and the second object 20 according to:

$${β}^{*} = arccos ( \frac{d {3}^{2} - c {1}^{2} - d {4}^{2}}{2 \cdot d 3 \cdot c 1} )$$

By comparing the first angle β calculated by the first transmitters 12, 14 and the first receiver 22 and the second angle β* calculated by the second transmitters 17, 19 and the second receiver 24, it can be determined whether the object is present at location P1 or at location P2. If the object 20 were located at the location P2, a different second angle β* than at the location P1 would result. Thus, the ratio of the calculated first angle β and the second angle β* indicates whether the second object 20 is present at the location P1.

A block diagram of the system 100 is shown in FIG. 4. The first object 10 is equipped with at least two transmitters 12 and 14. The first transmitter 12 transmits a first pulse signal S1 having a short pulse duration, and the second transmitter 14 transmits a second pulse signal S2 having a short pulse duration. However, a third transmitter 17 and a fourth transmitter 19 can be provided, wherein the third transmitter 17 transmits a third pulse signal S3 having a short pulse duration and the fourth transmitter 19 transmits a fourth pulse signal S4 having a short pulse duration.

The second object 20 is equipped with at least a first receiver 22. However, a second receiver 24 can in particular be provided. The pulse signal S1 transmitted by the first transmitter 12 is sent to the first receiver 22. The receiver 22 is configured so as to receive the pulse signals S1, S2 transmitted by the first transmitter 12 and the pulse signals S1, S2 transmitted by the second transmitter 14 and to return the first pulse signal S1 to the first transmitter 12 and the second pulse signal S2 to the second transmitter 14.

In particular, the transmitters 12, 14, 17, 19 are configured so as to generate the pulse signals P1, P2, P3, P4 using ultra-wideband (UWB) technology. UWB is a technology for short-range radio communication. Very large frequency ranges with a bandwidth of at least 500 MHz are used. As a result, pulse widths of very short duration up to the range of picoseconds can be produced. These then no longer contain complete sinusoidal vibrations. By contrast to conventional radio technology, no modulated carrier frequency is required, but rather individual pulses are generated.

The transmitters 12, 14, 17, 19 are each configured so as to determine a travel time Δt1, Δt2, Δt3, Δt4 from the pulse signals S1, S2, S3, S4 returned by the receivers 22, 24. The travel times Δt1, Δt2, Δt3, Δt4 can each be associated with a distance d1, d2, d3, d4 between the respective transmitter 12, 14, 17, 19 and the respectively associated receiver 22, 24. Transmitters 12, 14, 17, 19 can be equipped with a processor or a computational module in order to calculate the respective distance d1, d2, d3, d4 directly from the travel times Δt1, Δt2, Δt3, Δt4.

However, it can also be provided that the travel times determined by the transmitters 12, 14, 17, 19, Δt1, Δt2, Δt3, Δt4, are forwarded to a data processing module 30 via corresponding communications links, for example a CAN bus system (Controller Area Network). However, wireless connections can also be provided. The data processing module 30 contains a processor 32 and a memory module 34, and can be associated with a database 40 to retrieve further data for processing. In particular, the data processing module 30 can be connected to a cloud computing infrastructure 70 or other computing unit via a communications link 50. The database 40 can also be integrated into the cloud computing infrastructure 70.

Furthermore, the first object 10 can comprise a sensor module 15, in particular including a camera device. The camera device can comprise one or more cameras in the visible range and/or UV cameras in the ultraviolet range and/or IR cameras in the infrared range arranged at different positions on the first object 10. The data received by the sensor module 15 is also forwarded to the data processing module 30.

A “processor” can be understood in connection with the invention to mean, for example, a machine or an electronic circuit. In particular, a processor may be a master processor (central processing unit (CPU)), a microprocessor, or a microcontroller, for example an application-specific integrated circuit or a digital signal processor, optionally in combination with a memory unit for storing program instructions, etc. A processor may also be understood to mean a virtualized processor, a virtual machine, or a soft CPU. For example, it may also be a programmable processor equipped with configuration steps for carrying out the above-mentioned method according to the invention or configured with configuration steps in such a way that the programmable processor realizes the features according to the invention of the method, the component, the modules, or other aspects and/or partial aspects of the invention.

In the context of the present invention, a “memory unit” or “memory module” can be understood to mean, for example, a volatile memory in the form of a working memory (random access memory, RAM), or a permanent memory such as a hard drive or a data carrier or, for example, a replaceable memory module. However, the memory module can also be a cloud-based memory solution.

A “module” may, for example, be understood in connection with the invention to mean a processor and/or a memory unit for storing program instructions. For example, the processor is specifically configured to execute the program instructions in such a way that the processor and/or the control unit executes functions in order to implement or realize the method according to the invention or a step of the method according to the invention.

In the context of the invention, “data” can be understood to mean both raw data as well as data already prepared from measurement results of the transmitters 12, 14, 17, 19 as well as the sensor module 15.

“Database” means both a memory algorithm and the also hardware in the form of a memory unit. In particular, the database is configured as cloud computing infrastructure 70.

The communications link is in particular configured as a cellular link and/or a near field communications link such as Bluetooth®, Ethernet, NFC (near field communication), or Wi-Fi®.

In particular, the data processing module 30 and/or the transmitters 12, 14, 17, 19 and/or the sensor module 15 have cellular modules of the 5G standard. 5G is the fifth-generation cellular standard and, compared to the 4G cellular standard, is characterized by higher data rates up to 10 Gb/sec, higher frequency ranges such as 2100, 2600 or 3600 Megahertz, increased frequency capacity, and thus increased data throughput and real-time data transmission, because up to one million devices per square kilometer are responsive simultaneously. The latency time is a few milliseconds to below 1 ms, allowing real-time transmission of data and calculation results. The pulse signals received from the transmitters 12, 14, 17, 19 can be sent in real time to the cloud computing infrastructure 70, where the corresponding analysis and calculation of the distance d and the angle β is performed. The analysis and calculation results can be returned to the data processing module 30 or another control module in the first object 10. There, they can be used directly for further functions. However, they can also be initially stored to be used at a later time, or they are output via an output module to a user.

The data processing module 30 can be a separate unit in terms of hardware characteristics, but can also rely on other hardware and software components in the first object 10, such as transmitters 12, 14, 17, 19, or in the cloud computing infrastructure 70 for functional purposes.

Algorithms of artificial intelligence, wherein in particular neural networks, can be used in order to process the data received by the sensor module 15 and/or the travel times Δt1, Δt2, Δt3, Δt4 determined by the transmitters 12, 14, 17, 19 for calculating the distance d and the angle β.

A neural network consists of neurons arranged in multiple layers and interconnected to one another differently. A neuron is able to receive information at its input from outside or from another neuron, evaluate the information in a particular manner, and pass it on in altered form at the neuron output to another neuron, or output it as a final result. Hidden neurons are located between the input neurons and the output neurons. Depending on the type of network, multiple layers of hidden neurons can be present. They provide the forwarding and processing of the information. Output neurons finally deliver a result and issue it to the outside world. The arrangement and linkage of the neurons create different types of neural networks, such as feed-forward networks, recurrent networks, or convolutional neural networks. The networks can be trained through unsupervised or supervised learning.

In FIG. 5, the method steps for determining the position of a moving first object 10 relative to another second object 20 are described.

In a step S10, a first pulse signal S1 having a short temporal pulse duration is transmitted from a first transmitter 22 of the second object 20 to a first receiver 12 of the first object 10, and the first pulse signal S1 is returned from the first receiver 22 of the second object 20 to the first transmitter 12 of the first object, wherein a first distance d1 between the first transmitter 22 and the first receiver 12 can be derived from a travel time Δt1 of the first pulse signal S1.

In a step S20, a second pulse signal S2 having a short temporal pulse duration is transmitted from a second transmitter 14 of the first object 10 to the first receiver 12 of the second object 20, and the second pulse signal S2 is returned from the first receiver 22 of the second object 20 to the second transmitter 14 of the first object 10, wherein a second distance d2 between the second transmitter 14 and the first receiver 22 can be derived from a travel time Δt2 of the first pulse signal S2.

In a step S30, the first distance d1 and/or the travel time Δt1 of the first pulse signal S1 and the second distance d2 and/or the travel time Δt2 of the second pulse signal S2 are forwarded to a data processing module 30.

In a step S40, a distance d and an angle β between the first object 10 and the second object 20 are calculated.

FIG. 6 schematically shows a computer program product 200 comprising an executable program code 250 that is configured so as to perform the method according to the first aspect of the present invention.

With the method and system 100 according to the present invention, the position of a moving object relative to another object can thus be determined reliably and in real time by means of simple trigonometric calculations. By using transmitters that generate the pulse signals of short temporal pulse duration by means of ultra-wideband (UWB) technology in conjunction with fast computational times, an inexpensive solution is created that is also suitable for broad use in practice, in addition to testing purposes.

In a further development, it can also be provided that any number of objects 10, 20 are equipped with transmitters and receivers so that the positions of an object 10 can be determined relative to a plurality of other objects 20. In particular, an object can be equipped with transmitters as well as receivers, so that its own position can be determined and other objects can also be given the opportunity to determine the position from this object, in turn.

### REFERENCE NUMBERS

10 First object
12 First transmitter
14 Second transmitter
15 Sensor module
17 Third transmitter
19 Fourth transmitter
20 Second object
22 First receiver
24 Second receiver
30 Data processing module
32 Processor
34 Memory module
40 Database
50 Communications link
70 Cloud computing infrastructure
100 System
200 Computer program product
250 Program code

1. A method for determining the position of a moving first object (10) relative to another second object (20), comprising the following method steps:
transmitting (S10) a first pulse signal (S1) having a short temporal pulse duration from a first transmitter (12) of the first object (10) to a first receiver (22) of the second object (20), and returning the first pulse signal (S1) from the first receiver (22) of the second object (20) to the first transmitter (12) of the first object (10), wherein a first distance (d1) between the first transmitter (12) and the first receiver (22) can be derived from a travel time (Δt1) of the first pulse signal (S1);
transmitting (S20) a second pulse signal (S2) having a short temporal pulse duration from a second transmitter (14) of the first object (10) to the first receiver (22) of the second object (20) and returning the second pulse signal (S2) from the first receiver (22) of the second object (20) to the second transmitter (14) of the first object (10), wherein a second distance (d2) between the second transmitter (14) and the first receiver (22) can be derived from a travel time (Δt2) of the second pulse signal (S2);
forwarding (S30) the first distance (d1) and/or the travel time (Δt1) of the first pulse signal (S1) and the second distance (d2) and/or the travel time (Δt2) of the second pulse signal (S2) to a data processing module (30);
calculating (S40) a distance (d) and an angle (1) between the first object (10) and the second object (20).

2. The method according to claim 1, wherein, for calculating the distance (d) and the angle (β) between the first object (10) and the second object (20), the law of cosines for planar triangles from trigonometry is used, wherein c is the distance between the first transmitter (12) and the second transmitter (14):
c²=d1²+d2²−2·d1·d2·cos γ

3. The method according to claim 1 or 2, wherein a sensor module (15) is used in particular with a camera device for recording further data in order to limit the possible location of the second object (20).

4. The method according to any one of claims 1 to 3, wherein the first object (10) comprises a third transmitter (17), which transmits a third pulse signal (S3) having a short temporal pulse duration to a second receiver (24) of the second object (20), which signal is returned from the second receiver (24) of the second object (20) to the third transmitter (17) of the first object (10), wherein a third distance (d3) between the third transmitter (17) and the second receiver (24) can be derived from a travel time (Δt3) of the third pulse signal (S3).

5. The method according to claim 4, wherein the first object (10) comprises a fourth transmitter (19), which transmits a fourth pulse signal (S4) having a short temporal pulse duration to the second receiver (24) of the second object (20), which signal is returned from the second receiver (24) of the second object (20) to the fourth transmitter (19) of the first object (10), wherein a fourth distance (d4) between the fourth transmitter (19) and the second receiver (24) can be derived from a travel time (Δt4) of the fourth pulse signal (S4).

6. The method according to any one of claims 1 to 5, wherein the pulse signals (P1, P2, P3, P4) are generated by means of ultra-wideband (UWB) technology.

7. The method according to any one of claims 1 to 6, wherein the data processing module (30) and/or the transmitters (12, 14, 17, 19) are in communication with a cloud computing infrastructure (70) by means of a communications link (50), and wherein the communications link is configured as a cellular link and/or a near field communications link, such as Bluetooth®, Ethernet, NFC (near field communication), or Wi-Fi®.

8. The method according to any one of claims 1 to 7, wherein the data processing module (30) comprises algorithms of artificial intelligence and machine learning, in particular neural networks.

9. The method according to any one of claims 1 to 8, wherein the transmitters (12, 14, 17, 19) and/or the data processing module (30) are equipped with radio modules of the 5G standard.

10. The method according to any one of claims 1 to 9, wherein the objects (10, 20) are configured as a motor vehicle or as a self-driving vehicle or as an agricultural vehicle such as a combine harvester or as a robot or as a cleaning device such as a self-driving cleaning robot or as a watercraft or as a flying object such as a drone.

11. A system (100) for determining the position of a moving first object (10) relative to another second object (20), having a data processing module (30), wherein the first object (10) comprises at least a first transmitter (12) and at least a second transmitter (14), and the second object (20) comprises at least a first receiver (22); wherein the first transmitter (12) is configured so as to transmit a first pulse signal (S1) having a short temporal pulse duration to the first receiver (22), and the first receiver (22) is configured so as to return the first pulse signal (S1) to the first transmitter (12), and the first transmitter (12) is configured so as to forward a travel time (Δt1) of the first pulse signal (S1) to the data processing module (30), wherein the second transmitter (14) is configured so as to transmit a second pulse signal (S2) having a short temporal pulse duration to the first receiver (22), and the first receiver (22) is configured so as to return the second pulse signal (S2) to the second transmitter (14), and the second transmitter (14) is configured so as to forward a travel time (Δt2) of the second pulse signal (S2) to the data processing module (30); and wherein the data processing module (30) is configured so as to derive a first distance (d1) between the first transmitter (12) and the first receiver (22) from the travel time (Δt1) of the first pulse signal (S1) and to derive a second distance (d2) between the second transmitter (14) and the first receiver (22) from the travel time (Δt2) of the second pulse signal (S2) to calculate therefrom a distance (d) and an angle (1) between the first object (10) and the second object (20).

12. The system (100) according to claim 11, wherein, for calculating the distance (d) and the angle (β) between the first object (10) and the second object (20), the law of cosines for planar triangles from trigonometry is used, wherein c is the distance between the first transmitter (12) and the second transmitter (14).
c²=d1²+d2²−2·d1·d2·cos γ

13. The system (100) according to claim 11 or 12, wherein the first object (10) comprises a third transmitter (17), and the second object (10) comprises a second receiver (24), wherein the third transmitter (17) of the first object (10) is configured so as to transmit a third pulse signal (S3) having a short temporal pulse duration to the second receiver (24) of the second object (20), and the second receiver (24) of the second object (20) is configured so as to return the third pulse signal (S3) to the third transmitter (17) of the first object (10), wherein a third distance (d3) between the third transmitter (17) and the second receiver (24) can be derived from a travel time (Δt3) of the third pulse signal (S3).

14. The system (100) according to any one of claims 11 to 13, wherein the transmitters (12, 14, 17, 19) are configured so as to generate pulse signals (P1, P2, P3) by means of ultra-wideband (UWB) technology.

15. A computer program product (200) comprising an executable program code (250), which is configured so as to carry out the method according to any one of claims 1 to 10.
